(19) United States
(12) Patent Application Publication
(10) Pub. No.: US 2021/0289255 A1
(43) Pub. Date: Sep. 16, 2021

(54) SYNCHRONIZATION OF MEDIA CONTENT ACROSS MULTIPLE PARTICIPANT DEVICES

(71) Applicant: Airtime Media, Inc., Brooklyn, NY (US)

(72) Inventors: Matthew BALINT, Milpitas, CA (US); James WONG, San Jose, CA (US); Jack STRONG, Austin, TX (US); Alice YANG, Redondo Beach, CA (US); Yip Ming WONG, Santa Clara, CA (US); Deepak SUNDAR, Union City, NJ (US); Rodrigo SIEIRO, Santa Maria (BR); Prakash RAMAKRISHNA, San Jose, CA (US); Dana MAJID, Amsterdam (NL); Jesse RABEK, Burnsville, NC (US)

(21) Appl. No.: 17/200,657

(22) Filed: Mar. 12, 2021

Related U.S. Application Data
(60) Provisional application No. 62/988,667, filed on Mar. 12, 2020.

(51) Int. Cl. H04N 21/43; H04N 21/242; H04N 21/835; H04N 21/258

(52) U.S. Cl. CPC H04N 21/43076; H04N 21/25816; H04N 21/835; H04N 21/242

(57) ABSTRACT

Media content can be synchronized across multiple participant devices. A set of participant devices may request access to stream media content from a content delivery network. Each participant device can send information relating to the playback of the media content to a coordination server. The coordination server can determine a synchronized time for playback of the media content such that all participant devices playback the media content simultaneously. The coordination server can instruct each participant device to playback the media content according to the synchronized time.

### CROSS-REFERENCE TO RELATED APPLICATIONS

This application claims the benefit of U.S. Provisional Patent Application No. 62/988,667, titled “SYNCHRONIZATION OF MEDIA CONTENT ACROSS MULTIPLE PARTICIPANT DEVICES,” filed Mar. 12, 2020, which is incorporated herein by reference in its entirety.

### TECHNICAL FIELD

Various embodiments concern computer programs and associated computer-implemented techniques for synchronization playback of media content across multiple network-accessible devices.

### BACKGROUND

Streaming of media content to network-accessible electronic devices is widely gaining popularity. Various media (e.g., sports broadcasts, movies) can be streamed to devices either in near-real time or on-demand from various broadcast services over a network (e.g., the Internet).

Further, in many instances, groups of participants would like to simultaneously view media content on a series of participant-specific devices at the same time. For instance, a number of fans of a sports team would like to simultaneously stream a sports broadcast featuring the sports team onto their participant-specific devices. In these instances, the group of participants may want to share reactions to events occurring in the media content to the other participants as the events occur on the participant-specific devices. Engaging with other participants while viewing media content may increase participant experience and entertainment when viewing the media content.

However, in many cases, multiple participants may have difficulties in simultaneously streaming media content at the same time. For example, a streaming server may deliver media content to various devices over a network with various offset times. The offset delivery of the media content to the devices may result in participants unable to view the media content on their devices at the same time.

As another example, each device may have varying network speeds and may have a network interruption event occur. If a device has a network interruption event occur, the device may be unable to render and display the media content at the same time of other devices. Such difficulties in simultaneously streaming media content at the same time may result in lower participant experience in interacting with the media content.

### BRIEF DESCRIPTION OF THE DRAWINGS

Various features of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 is an illustration of an example environment in which multiple clients can obtain synchronized media content.

FIG. 2 is a block diagram of an example network environment for synchronizing media content among a synchronization group.

FIG. 3 is a block diagram of example information maintained by the coordination server.

FIG. 4 is a flowchart depicting example synchronization states for a synchronization group.

FIG. 5 is a block diagram depicting example information capable of being stored by a playback manager.

FIG. 6 is a flow diagram depicting various example playback manager states.

FIG. 7 illustrates an example interface capable of being executed on a participant device.

FIG. 8 is a block diagram of an example network depicting multiple devices associated with each participant.

FIG. 9 is an example block diagram depicting multiple clients with example playlist segments associated with various streams.

FIG. 10 is a block diagram of an example method for synchronization of media content between participant devices.

FIG. 11 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

In many instances, multiple participants may want to simultaneously stream media content over a network at the same time. The participants, each on unique participant devices, can request a stream of the media content (e.g., sports broadcast, movie, online television broadcast) from a content delivery network (or “broadcast server”).

However, each participant device may obtain the stream of media content at time positions that are offset to one another. For example, a first participant can obtain and playback the media content with a 3 second delay, while a second participant can obtain and playback the media content with a 12 second delay. In such an instance, each participant may be unable to view the media content in real-time, which may lower user experience in viewing the media content. Further, the offsets between playback of media content on each participant device may increase based on other factors, such as geographic location of each participant device, network speeds, etc.

Further, in many cases, participants may want to both view the media content on participant devices simultaneously and communicate with one another in real time. In such cases, the participants can provide reactions to the events depicted in the media content in a video call between participants in real-time.

However, when playback of media content on each participant device is offset in relation to one other, user experience may be decreased. For example, participants with offset playback of media content may be unable to provide reactions to the events depicted in the media content in real-time. Additionally, when the media content transitions to or from advertisement segments, the offset in playback of the media content between each participant device may increase, as advertisement segments may differ between each stream and between different geographic regions.

Embodiments may be described with reference to particular computer programs, system configurations, networks, etc. However, those skilled in the art will recognize that these features are equally applicable to other computer program types, system configurations, network types, etc. For example, although the term “mobile application” may be used to describe a computer program, the relevant feature may be embodied in another type of computer program.

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform a process for implementing a handshake process in which parties confirm their readiness to participant in an interactive session.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

Technology Overview

The present embodiments relate to synchronization of media content playback on multiple participant devices. Multiple participants part of a synchronization group can have media content simultaneously played back on participant devices. Synchronization of the playback of media content may increase participant experience, as participants can view the content simultaneously and provide reactions to the media content in real time. Accordingly, the synchronization as described herein can be utilized with respect to simultaneous streaming of media content and video communication between participants.

As an illustrative example, each participant device can subscribe to or initiate playback of a sports broadcast. A coordination server can identify offset times in each stream for each participant device and instruct each device to playback the content at a synchronized time. The coordination server can achieve synchronization of playback of media content among all devices in the participant group by dynamically reporting a target playback position within the media content.

The client devices (or “participant device”) may report playback times of a position of media content to a coordination server. The coordination server can calculate various offset times in the media content for each client device. In response to varying offset times, the coordination server can send instructions to each client device to playback media at a common time position. Synchronizing playback of media content among devices can increase participant experience, as multiple participants experience the media content as if the participants are in the same physical location.

Media content may be synchronized while not modifying the underlying broadcast of media content provided by a broadcast server. Each participant can subscribe to the media content at the broadcast server and individually receive a stream of the media content at their participant device. Accordingly, each participant device can obtain a unique stream of the media content from a broadcast server over the internet, and the coordination server can coordinate playback of the media content on playback managers for participant devices.

In some embodiments, participants can react to events occurring in the media stream. For instance, a number of participants can react to a frightening moment in a horror movie playing back on participant devices. The present systems can detect a reaction by any of the participants and trigger modification of the player to including both the playback of media content as well as a video of the participant reacting to the media content. For instance, a camera disposed on a client device can capture an environment including the participant, and a computing device (e.g., the client device, coordination server, another server) can process the environment captured by the camera to determine whether the participant has triggered the reaction model.

In some embodiments, the system can include subtitles or captions representing words/actions taken in the media content on each participant device. The subtitles can be provided by the broadcast server or dynamically generated by the present system. The subtitles can be generated for any one of a number of languages, based on participant preference. In some cases, language in the media content can be detected and translated such that a unique audio track outputting translated language can be played back on each client device as requested by the participant. Accordingly, each participant in a participant group can have unique subtitles or an audio track outputting on each participant device while the media content remains synchronized across participants.

In some embodiments, each participant can engage with other participants as part of the synchronization group on multiple devices. For instance, a first device (e.g., network-accessible television set, a laptop computer) associated with the participant can playback the media content on a player of the first device that is synchronized as described herein, while a second device (e.g., a mobile phone, tablet) associated with the participant can implement a video call or audio call with the participants in the synchronization group. In other embodiments, a single device can implement both playback of media content as well as a video/audio call between participants.

In instances where multiple devices are utilized to view media content and engage with participants, various techniques can be implemented to remove/silence background audio from devices. For example, echo cancellation can be enabled to remove background audio of the media content on devices implementing a video call between participants.

In other embodiments, a single device can implement both playback of the synchronized streaming media content and implementation of the video/audio call as described herein. In such an instance, the display of the device can include portions of the display that each display the media content and the video/audio/call. The single device can implement the techniques to remove/silence background audio from devices as described herein.

In some embodiments, a content creator can create media content to be streamed to participants of a synchronization group. In these embodiments, the media content created by content creator can be offset such that a time period exists between generation of the media content and the playback of the media content on participant devices. This may allow for an editor via an editor device to review the media content created by the content creator and perform actions to modify the media content, if needed. For instance, the editor device can remove specific language or specific objects from the media content. The offset can allow for editing of the media content by an editor before streaming and playback of the media content by the participant devices.

In some embodiments, the present system can insert additional content (e.g., advertisements) into the streamed media content. For example, a movie streamed from a streaming service can be modified to include advertisements at specific positions in the movie.

The coordination server and/or the playback manager can determine whether streamed media content is currently broadcasting content or an advertisement. When it is determined that an advertisement section of the media content ends, the coordination server can re-synchronize playback of the media content to the participants.

In some embodiments, an advertisement insertion service associated with the media content provider can be integrated with an internal advertisement service. In these embodiments, advertisements for the media content provider can be first inserted during advertisement periods of the media content, while unused portions of the media content can include advertisements provided by the internal advertisement service.

As noted above, various participant devices can include various network speeds. In some cases, a participant device may experience a network interruption event. In such an event, the device may fail to receive, render, and playback the media content received over the network to maintain a time position common to participant devices in the synchronization group. In this event, all participants in the synchronization group may playback content from the internal advertisement service while the participant device experiencing the network interruption event attempts to re-establish the connection to the network to stream the media content.

In some embodiments, the system can include one or more task automation tools (or “bots”). A bot can be utilized to perform any of a variety of tasks, such as generate analytics relating to video synchronization quality, for example. As another example, a bot can inspect the media content, determine an action taking place in the media content (e.g., a scoring event in a sports broadcast), and generate appropriate stored audio depicting the media content. As another example, a bot can obtain audio in the media content, dynamically translate the language, and output the translated language to specific participant devices.

As noted above, the present embodiments describe methods and systems to synchronize the playback of media content. Media content can be transmitted to multiple client devices using a streaming protocol (e.g., HLS, DASH) with high precision (e.g., ˜100 ms). In this way, participants can achieve the experience of watching the same show or a sports event together, even if the participants are physically separated.

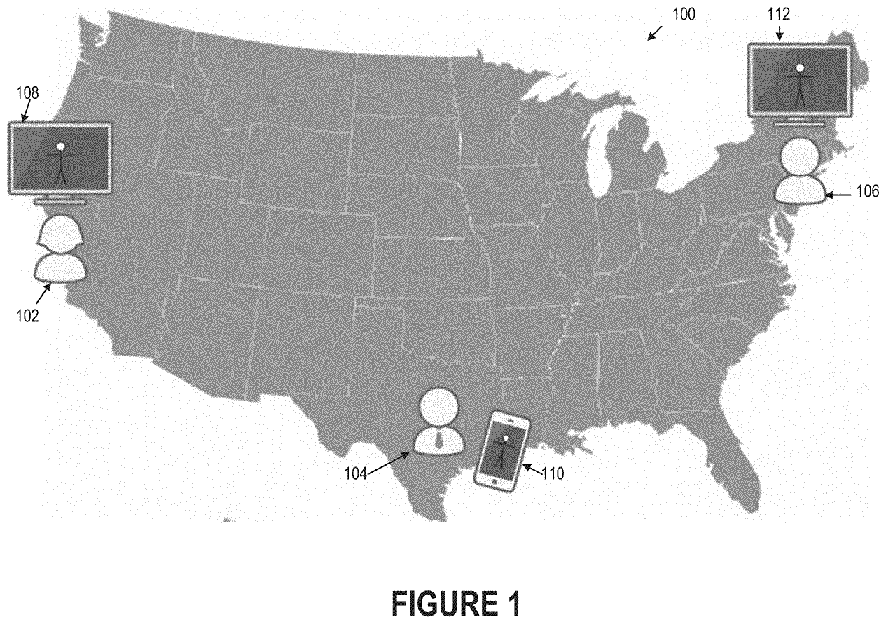

FIG. 1 is an illustration of an example environment 100 in which multiple clients can obtain synchronized media content. As shown in FIG. 1, multiple clients (e.g., clients 102, 104, 106) can be physically located in different regions.

The multiple clients can view a synchronized media content via client devices (e.g., devices 108, 110, 112). Client devices can include a network-accessible electronic device, such as a computer, tablet, mobile phone, etc.

As described in greater detail below, client devices can playback media content (e.g., sports event, live broadcast, movie, audio) in a synchronized fashion. In other words, client devices can obtain instruction from a synchronization server to output media content at a common time across the client devices.

The group of clients that are to receive the synchronized media content may be referred to as a synchronization group. A client can include any participant participating in the synchronization group. A server can include a host device that manages the synchronization group.

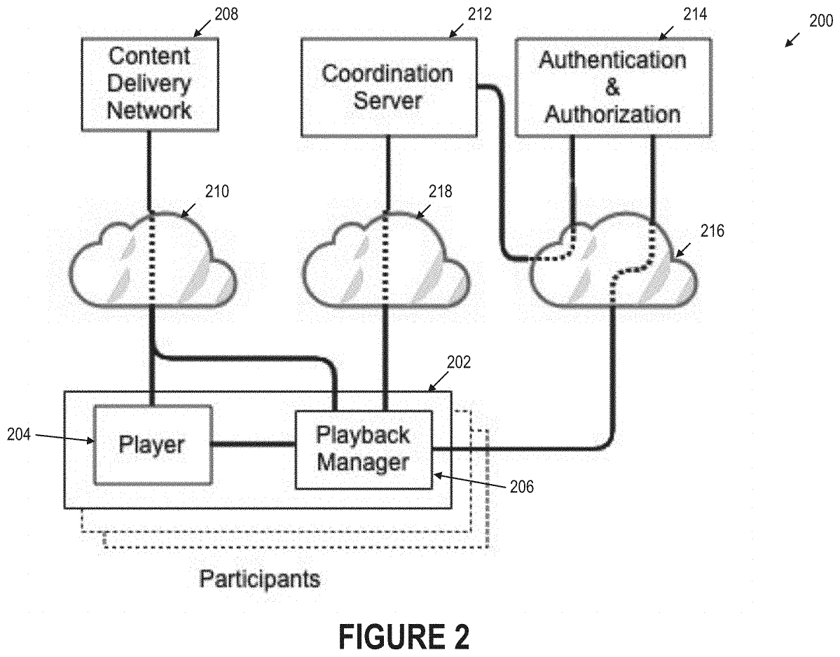

FIG. 2 is a block diagram of an example network environment 200 for synchronizing media content among a synchronization group. As shown in FIG. 2, the network environment can include a participant device 202. The participant device 202 can include any of a player 204 and a playback manager 206 to facilitate playback of the synchronized media content.

A content delivery network 208 can deliver content to the participant device 202 via a first network 210. A coordination server 212 can communicate with any of an authentication and authentication node 214 via a second network 216 and the participant device 202 via the second network 216. The authentication and authentication node 214 can communicate with participant device 202 via a third network 218.

An authentication & authorization node 214 can provide authorization tokens to clients who wish to participate in a synchronization session. Clients with valid tokens can be provided with a unique client session identifier to use in protocol messages.

The coordination server 212 can manage a synchronization session state of the media content and can continually report the target playback to the participant devices.

### Coordination Server Data

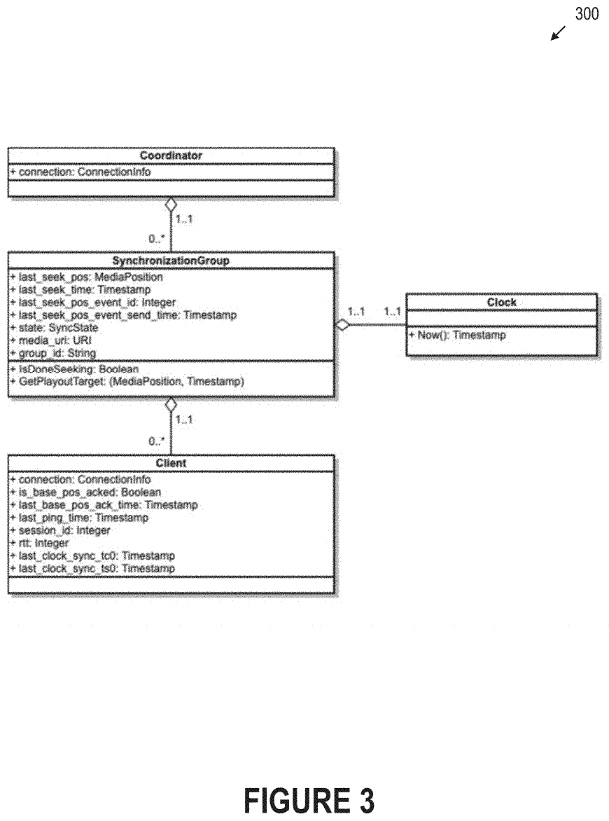

The coordination server can store various information relating to synchronizing media content playback to the client devices. FIG. 3 is an example block diagram 300 of information maintained by the coordination server.

The information can include a media position that includes a position in the media stream. For example, the media position includes a time difference required to play out all media in the stream up to the position. As another example, the media position includes a segment identifier and offset within the segment.

The information can include a timestamp that includes a representation of a specific time. The information can include a Uniform Resource Identifier (URI), (e.g., as per RFC 3986).

The information can include a synchronization state (SyncState), which may include the overall state of a Synchronization Group. For example, SyncState can include one of start, seek_play, play, seek_pause, pause, end, etc. The SyncState is described in greater detail below.

The information can include connection information (ConnectionInfo) that can include information necessary to send and receive messages over a network. The information can include a duration representative of a length of time.

The information can include an AverageAlgorithm that can include an algorithm to use to determine the average media position given a set of pairs (e.g., media position, weight pairs). The AverageAlgorithm can be indicative of one of a WeightedMean or WeightedMedian.

The information can include an InterpolationAlgorithm that can represent an algorithm to use to interpolate values between known endpoints. For example, the algorithm can be linear or exponential.

The coordinator can include root server information. Example root server information can include connection information that indicates network connection information that allows the coordination server to receive messages from client devices. Another example of root server information can include group information that includes a list of SynchronizationGroup objects, one for each active Synchronization Group. In some cases, the SynchronizationGroup objects may be empty.

The coordination server may include information for a specific active synchronization group. This information can include a last seek position (last_seek_pos), which can include the last position that clients were requested to seek to in the media stream. This information can also include a last seek time (last_seek_time), which can include the playout time for last_seek_pos, using the Coordination Server's synchronization clock.

The synchronization clock can include a clock that is synchronized across all participating devices using the time synchronizing steps as described herein.

This information can also include a last seek event identifier (last_seek_event_id), which can include an identifier of the seek position synchronization message corresponding to last_seek_pos. The value can be unique within this Synchronization Group.

This information can also include a last seek position event sent time (last_seek_pos_event_sent_time), which can include the synchronization clock time that the base position synchronization message corresponding to last_seek_pos was sent.

This information can include state information, which can include the current synchronization state. This information can also include a media URI (media_uri), which can include the Uniform Resource Identifier for the media stream to be synchronized. This information can also include a group identifier (group_id), which can include a globally unique tag used by clients to identify the synchronization group.

This information can also include a list of Client objects, one for each participating client participating in this SynchronizationGroup. This information can also include the clock used to synchronize times for the participants in the Synchronization Group.

The coordination server can store client data that is specific for a member of the synchronization group. The client data can include connection information that can be indicative of network connection information that allows the coordination server to send messages to a specific client.

The client data can include a last acknowledgement seek position (last_ack_seek_pos), which may include the last position that the client reported seeking to.

The client data can include a last seek position acknowledgment request time (last_seek_pos_ack_request_time). This may include the last time that a request was sent to the client to use the current Synchronization Group last_seek_pos.

The client data can include a last ping time (last_ping_time). This may include the last time that the Synchronization Server received a message from the client.

The client data can include a session identifier (session_id), which may include the client's unique identifier. The client data can include a round trip time (rtt), which may include an Estimated Round Trip Time for messages sent to the client.

The client data can include a last local clock synchronization time (last_clock_sync_tc0), which may include the last reported client local time. This may be used as part of the clock synchronization protocol.

The client data can include a last server clock synchronization time (last_clock_sync_ts0), which may include the last time that the server received a clock synchronization message from the client. This can be used as part of the clock synchronization protocol.

The coordination server may include a series of constants that control the specific behavior of the Coordination Server. A constant can include a kMaxBasePosAckWaitDuration, which may be the maximum time that the Coordination Server will wait for clients to acknowledge that they are using base_pos as the playout base position before it considers them to be late in acknowledging the event.

Another example constant can include a kPosToTimeFactor, which can be a factor used to convert a difference in positions in a media stream to an equivalent time duration.

Another example constant can include a kTimeToPosFactor, which can include a factor used to convert a time duration into a difference in positions in a media stream.

Another example constant can include a kMinUpdateInterval, which can include a minimum interval between playout target updates.

Another example constant can include a kTargetPosAverageAlgorithm, which can include the algorithm to find the average target position in a media stream.

Another example constant can include a kClientPosWeight, which can include a factor to apply to the weight of a position reported by a client.

Another example constant can include a kServerPosWeight, which can include a factor to apply to the weight of the reference position calculated by the server.

Another example constant can include a kLowBitrateWeight, which can include a factor to apply to the weight of the position reported by the client with the lowest reported stream bitrate.

Another example constant can include a kHighBitrateWeight, which can include a factor to apply to the weight of the position reported client with the highest reported stream bitrate.

Another example constant can include a kBitrateWeightInterpolationAlgorithm, which can include an algorithm to use to interpolate the factor to apply to the weight of clients whose reported stream bitrate falls between the lowest reported stream bitrate and the highest reported stream bitrate.

Another example constant can include a kOldestClientUpdateWeight, which can include a factor to apply to the weight of the position reported by the client with the oldest update that is older than kRecentClientUpdateTime.

Another example constant can include a kRecentClientUpdateWeight, which can include a factor to apply to the weight of the position reported by a client whose position was updated within kRecentClientUpdateTime.

Another example constant can include a kRecentClientUpdateTime, which can include a maximum age of a position update from a client for it to be considered recent.

Another example constant can include a kAgeWeightInterpolationAlgorithm, which can include an algorithm to use to interpolate the factor to apply to the weight of clients whose last position report is older than kRecentClientUpdateTime but earlier than that of the oldest position report.

Another example constant can include a kLowBufferWeight, which can include a factor to apply to the weight of the position reported by clients that are farthest behind and whose buffers are under the kMinBuffer.

Another example constant can include a kMinBuffer, which can include the minimum buffer size for a client to be considered to have an adequate buffer, expressed as a difference in positions in a media stream.

Another example constant can include a kNoPos, which can include a special value indicating an unknown or invalid position in a media stream.

### Synchronization Group State

The Coordination Server can maintain separate states for each Synchronization Group. For example, the states for a synchronization group can include a “start” state indicative of an indication to start the media content, a “pause” state to pause the media content, etc.

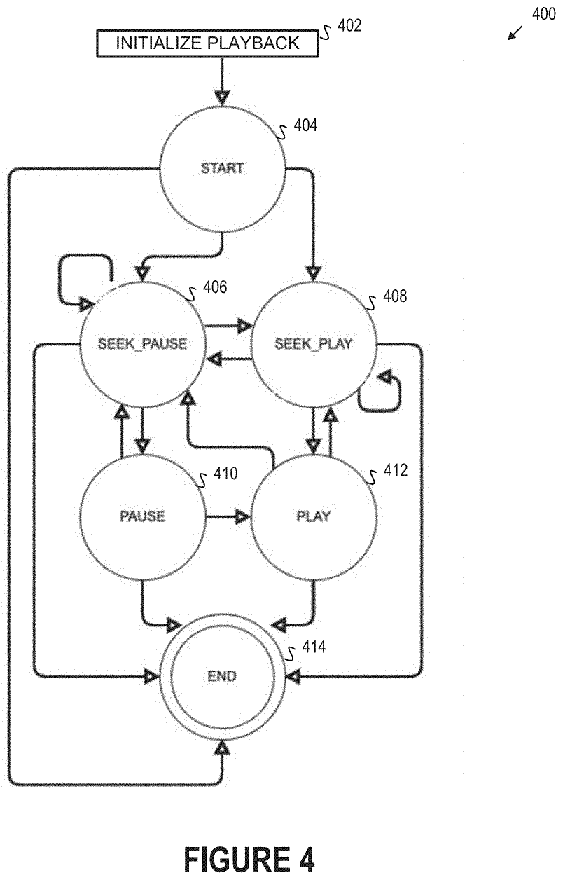

FIG. 4 is an example flowchart 400 depicting synchronization states for a synchronization group. As shown in FIG. 4, playback can initialize 402, which can include initializing playback of media content.

Example synchronization states can include any of a “start” state 404, a “seek_pause” state 406, a “seek_play” state 408, a “pause” state 410, a “play” state 412, and an “end” state 414.

The start state may be the initial state that is entered as a first client connects to the coordination server. The start state may transition to another state based on a trigger. For example, if a start_paused trigger is false, the new state is seek_play. Alternatively, if a start_paused trigger is true, the new state is seek_pause. If a fatal error is detected, the state is transitioned to an end state.

The seek_play state may include a state that is waiting for clients to move to the base_pos position so that play can resume from that position in the media stream. The seek_play may transition to another state based on a trigger. For instance, if a seek_request message is obtained, the new state is seek_play

If a pause_request message is received, the new state transitions to seek_pause. If all clients either report that they are waiting at base_pos or time out, the state transitions to play. If no more clients are connected or if a fatal error occurred, the state transitions to an end state.

The play state can include a state that periodically sends the current server position in the media stream to clients. The play state can transition based on a trigger. For instance, if a seek_request message is received, the state is transitioned to seek_play. If a pause_request message is received, the state is transitioned to seek_pause. If no more clients are connected or a fatal error occurred, the state is transitioned to an end state.

A seek_pause state may include waiting for clients to move to the base_pos so that they will all hold at the same position in the media stream. The seek_pause state can transition based on a trigger. For instance, if a PLAY_REQUEST message is received, the state is transitioned to SEEK_PLAY. If a SEEK_REQUEST message is received, the state is transitioned to SEEK_PAUSE. If all clients either report that they are waiting at base_pos or time out, the state transitions to a pause state. If no more clients are connected or a fatal error occurred, the state transitions to an end state.

A pause state includes holding clients at the current base_pos. The pause state can transition to a seek_pause state if a seek_request message is received. If a PLAY_REQUEST message is received, the state can transition to a play state. If no more clients are connected or a fatal error occurred, the state transitions to an end state.

An end state may shut down the synchronization group.

### Synchronization Group Derived Values

A Synchronization Group object can provide various methods to calculate values. For instance, an IsDoneSeeking( ) object can return true if seeking to a position in the media stream is complete.

Specifically, seeking is complete when the following conditions are true. A first condition can include if there is at least one client in group.clients where client.last_ack_seek_pos=group.last_seek_pos. Another condition can include when there is no client in group.clients where: client.last_ack_seek_pos !=group.last_seek_pos and group.clock.Now( )-client.last_seek_pos_event_sent_time>kMaxBasePosAckTime.

Another object can include a GetPlayoutTarget( ) that returns the target playout position and playout time to send to clients.

The subset of clients that have already identified a seek to group.base_pos can set the weight of their reported positions to the base client weight. Other clients can be ignored since they are still buffering.

```
let clients ← EMPTY_SET
For each client in group.clients where client.last_ack_seek_pos =
group.last_seek_pos :
  participating_clients ← participating_clients U client
let client_to_weight ← EMPTY_DICTIONARY
For each client in group.clients where client.last_ack_seek_pos =
group.last_seek_pos :
  client_to_weight.insert ( client, group.kClientPosWeight)
```

The weights for the reported client positions can be adjusted based on the bitrates. In this way, the algorithm may be tuned to favor clients streaming high or low quality variants.

```
let min_bitrate ← MIN(clients.playout_bitrate)
let max_bitrate ← MAX(clients.playout_bitrate)
let data_point_low ← f(min_bitrate) = group.kLowBitrateWeight
let data_point_high ← f(max_bitrate) = group.kHighBitrate Weight
For each client in clients:
  let weighting_factor ← INTERPOLATE(
  kBitrateWeightInterpolationAlgorithm, data_point_low,
  data_point_high , client.playout_bitrate) client_to_weight [client]
  ← client_to_weight [client] * weighting_factor
```

The weights for the reported client positions can be adjusted based on how recent the reported positions are. In this way, the algorithm may be tuned to favor older or newer results.

```
let oldest_age ← group.clock .Now( ) - MIN(clients.
last_playout_pos_update)
let oldest_recent_age ← group.clock .Now( ) - kRecentClientUpdateTime
let data_point_old ← f( oldest_age ) = kRecentClientUpdateWeight
let data_point_new ← f( oldest_recent_age ) =
kRecentClientUpdateWeight
For each client in clients:
  let age ← group.clock .Now( ) - client.last_playout_pos_update
  let weighting_factor ← kRecentClientUpdateWeight
  If (age > oldest_recent_age) then:
    weighting_factor ← INTERPOLATE(
    kAgeWeightInterpolationAlgorithm,
  data_point_old, data_point_new , age )
  client_to_weight [client] ← client_to_weight [client] *
  weighting_factor
```

The current baseline playout position can be estimated using the server's base position.

let time_since_base_pos ← group.clock .Now( ) - group.last_seek_time
let current_server_pos ← group.last_seek_pos * ( time_since_base_pos *
kTimeToPosFactor)

Each client's current playout position can be estimated, ignoring any that have not yet identified a seek to group.base_pos.

```
let client_to_pos ← EMPTY_DICTIONARY
For each client in clients:
  let time_since_last_client_pos ← group.clock .Now( ) -
  client.last_client_pos_time
  let current_client_pos ← client.last_client_pos * (
  time_since_last_client_pos *
  group.kTimeToPosFactor )
  client_to_pos.insert ( client, current_client_pos )
```

The weight of the clients that are furthest behind can be changed if they are close to exhausting their buffers. In this way, the algorithm may be tuned to favor giving clients that are behind a chance to buffer more data.

```
let min_client_pos ← MIN(VALUES( client_to_pos ))
For each client in clients where client_to_pos [ client ] = min_client_pos:
  let buffer_left ← client.max_buffered_pos - clientlast_client_pos
  If ( buffer_left < kMinBuffer ) then:
    client_to_pos [client] ← client_to_pos [client] *
    kLowBufferWeight
```

The weighted average of the set of positions can be calculated.

```
let position_weight_pairs ← { current_server_pos, kServerPosWeight }
For each client in clients:
  position_weight_pairs.insert ({ client_to_pos [ client ],
  client_to_weight [ client ]})
let target_pos ← WEIGHTED_AVERAGE( kTargetPosAverageAlgorithm ,
position_weight_pairs)
```

The target playback position may be bound so that it does not exceed the maximum playback position.

target_playback_pos ← MIN( target_playback_pos , MIN( clients .
max_playout_pos))

Bound the target playback position can be bound so that it does not exceed the minimum playback position.

target_playback_pos ← MAX( target_playback_pos , MAX( clients.
min_playout_pos))

Return {target_playback_pos, group.clock.Now( )}

### Examples of Tuning the Playout Target Position Calculation

As described below, the constants may be set to achieve various behaviors. For instance, if a setting include all weights←1, the calculations are simplified to just take a simple average of the positions.

As another example, if the settings include kClientPosWeight←1 and kServerPosWeight←0, only playback position reports from Clients are considered. This can prevent the calculated server position from pushing the playback position too far ahead when all clients are struggling.

As another example, if kClientPosWeight←0 and kServerPosWeight←1, only the calculated server position is used. This can greatly simplify the calculations but may require that all clients be able to maintain uninterrupted playback.

As another example, if kHighBitrateWeight←0.5, kLowBitrateWeight←1, and kBitrateWeightInterpolationAlgorithm←LINEAR, the weight of clients streaming the lowest quality variants of the media stream may be increased such that the lowest bitrate client will have 2× the weight of the highest bitrate client, with other clients weighted proportionally to their bitrates. This can help slow down playback if clients chose the low bitrate variant because of they are having trouble keeping up with the playback.

A Synchronization Group's synchronized clock object can provide any of a variety of methods. As an example, Now( ) returns the current time from the server's local system clock. This can be both the local and synchronized time since the clients synchronize their times to the server clock.

### Playback Manager

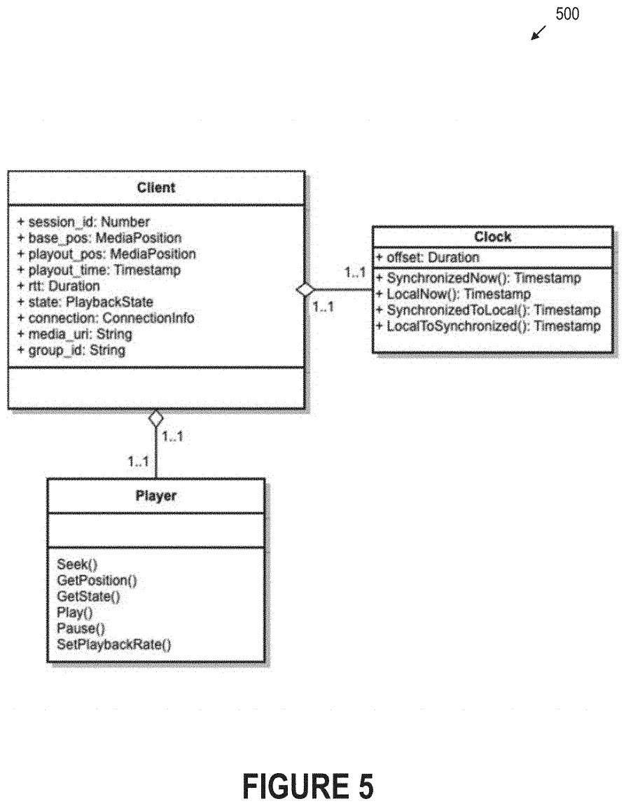

Playback Managers can control the playback of the media on the client device to maintain synchronization. FIG. 5 is an example block diagram 500 depicting information capable of being stored by a playback manager.

The playback manager can include data of various types. For instance, this can include MediaPosition information, which can include a position in a media stream. For example, this can include the time difference required to play out all media in the stream up to the position. As another example, this can include a segment identifier and offset within the segment.

Another type of data can include a timestamp, which can be a representation of a specific time.

Another type of data can include a URI, as per RFC 3986, for example.

Another type of data can include ConnectionInfo, which can include information necessary to send and receive messages over a network.

Another type of data can include a duration indicative of a length of time.

Another type of data can include PlaybackState, the overall state of a Playback Manager. For example, this can include one of START, SEEK_PLAY, PLAY, SEEK_PAUSE, PAUSE, END, etc.

The playback manager can include client information. An example of client information can include a session_id, which can include the client's unique identifier. Another example includes a base_pos, which can include the position in the media stream that will be used as a reference position for playout positions.

Another example includes a playout_pos, which can include the last target playout position. Another example includes a playout_time, which can include the target time to play out playout_pos. Another example includes an offset, which can include an offset to add to times from the Coordination Server to convert them to local times.

Another example includes an RTT, which can include an estimated round trip time to the server. Another example includes a current state. Another example includes a connection indicative of network connection information that allows the Playback Manager to send messages to, and receive messages from, the Coordination Server.

Another example includes a media_uri, which can include the Uniform Resource Identifier of the media stream. Another example includes a group_id, which can include a globally unique tag used by clients to identify the synchronization group.

Another example includes a player, which can include the streaming media player used to playback and query the state of the media_uri stream. Another example includes a clock indicative of the synchronized clock.

The playback manager can include clock information that includes an offset used to maintain synchronization between Coordination Server and Playback Manager times.

The playback manager can include constants that can control the specific behavior of the Playback Manager.

An example constant can include kMinUpdateInterval, a minimum interval between reports of the current playback state.

Another example constant can include kInSyncThreshold, the maximum difference between the actual and target playout times of the target playout position for a client to be considered to be fully synchronized. Fully synchronized clients will playback normally.

Another example constant can include kCloseSyncThreshold, the maximum difference between the actual and target playout times of the target playout position for a client to be considered to be closely synchronized. Closely synchronized clients may adjust playback parameters, such as playback rate, to improve synchronization. The constant may be >=kInSyncThreshold.

### Playback Manager States

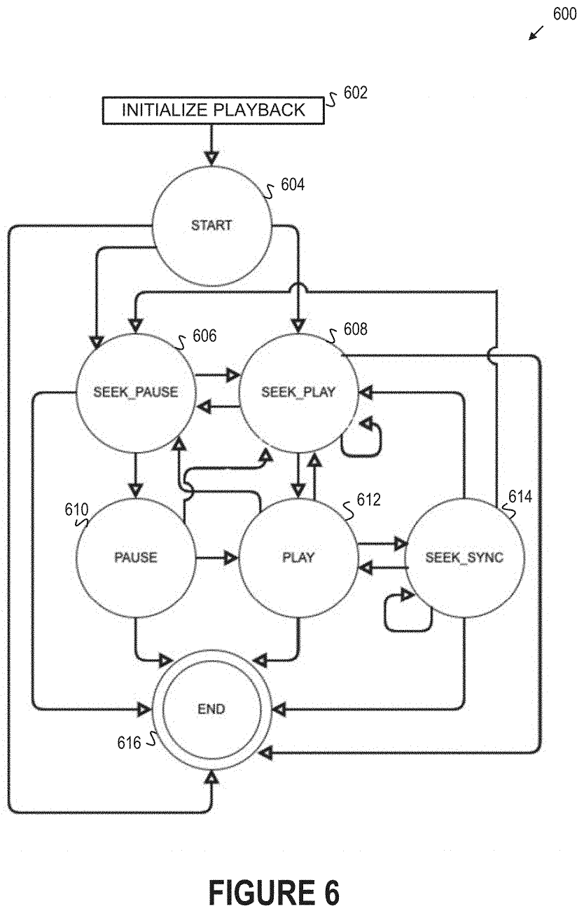

FIG. 6 is an example flow diagram 600 depicting various playback manager states. One such state can include a start stat, which can include an initial state upon sending a request to join a Synchronization Group. If the client receives a seek_play message, the state may transition to seek_play. If the client receives a seek_pause message, the state may transition to seek_pause. If the client ended feedback or a fatal error occurred, the state may transition to end.

As shown in FIG. 6, the flow diagram 600 can include initializing playback 602. Example states can include a start state 604, a seek_pause state 606, a seek_play state 608, a pause state 610, a play state 612, a seek_sync state 614, an end state 616, etc.

A seek_pause state may indicate that a player is moving to a new position to hold at. The state may transition to seek_play if a seek_pause message is received. The state may transition to pause if the player reports that it is ready to play out at the requested position. The state may transition to end if the client ended playback or a fatal error occurred.

A pause state may indicate that the player is holding at the base_pos. If the client receives a SEEK_PLAY message the state can transition to seek_play. If the client receives a PLAY message and playout_time is >=clientSynchronizedNow( ), the state is transitioned to play. If the client ended playback or a fatal error occurred, the state is transitioned to end.

A seek_play state may include a state that the player is moving to a new playout position. If the client receives a seek_pause message, the state can transition to seek_pause. If the client receives a new seek_play message, the state remains in seek_play. If the player reports that it is ready to play out at the requested playout position, the state can transition to play. If the client ended feedback or if a fatal error occurred, the state can transition to end.

A play state can be a state where the media stream is playing. If the client receives a new seek_pause event, the state transitions to seek_pause. If the client receives a new seek_play event, the state transitions to seek_play. If the playback manager calculates a new playback position that the player needs to seek to in order to maintain sync, the state transitions to seek_sync. If the client ended playback or if a fatal error occurred, the state transitions to end.

A SEEK_SYNC state can include a state where a player is moving to a new position to maintain sync. If the client receives a seek_pause message, the state can transition to seek_pause. If the client receives a seek_play message, the state can transition to seek_play. If the playback manager calculates a new playback position that the player needs to seek to in order to maintain sync, the state can stay at seek_sync. If the client ended playback or if a fatal error occurred, the state can transition to end.

An end state can include shutting down the playback manager.

### Playback Manager Calculations

A Playback Manager object can provide any of a variety of methods. A first method can include an UpdatePlayback( ) object. This can update the playback state based on a given playout_target. The Playback Manager can query the Player to find the local playback position and compares the server playout time, advanced to the current time, to its own playout time.

let local_playout_time ← clock .SynchronizedToLocal(
playout_target.time)
let delta_time ← clock .LocalNow( ) - local_target_playout_time
let local_playout_pos ← playout_target. pos + (delta_time *
client.kTimeToPosFactor )
let sync_delta_time ← (player. PlayoutPos ( ) - local_playout_pos) *
client.kPosToTimeFactor

The Playback Manager may adjust playback speed or seek to a new playback position depending on how close its own playback time matches the target time. A condition can include |sync_delta_time|<=client.kInSyncThreshold. The corresponding action can include the delta between the target and actual playout times is satisfactory. Playback at normal speed. player.set_playback_rate(1).

Another condition can include client.kCloseSyncThreshold>=|sync_delta_time|>client.kInSyncThreshold && sync_delta_time>0. In this condition, Playback is ahead. Reduce playback rate, proportional to how far off the synchronization is, to get back in sync. The playback rate is bounded by a minimum playback rate.

let target_playback_rate ← 1 -
(sync_delta_time / kConvergenceTime)
target_playback_rate ←
MAX( kMinPlaybackRate,
target_playback_rate)
player.set_playback_rate(target_playback_rate)

Another condition can include client.kCloseSyncThreshold>=|sync_delta_time|>client.kInSyncThreshold && sync_delta_time<0. In this condition, playback is behind. Increase playback rate, proportional to how far off the synchronization is, to get back in sync. The playback rate is bounded by a maximum playback rate.

let target_playback_rate ← 1 +
(sync_delta_time / kConvergenceTime)
target_playback_rate ←
MAX( kMaxPlaybackRate,
target_playback_rate)
player.set_playback_rate(target_playback_rate)

Another condition can include/sync_delta_time|>client.kCloseSyncThreshold. In this condition, playback is significantly out of sync. Seek to the expected position plus a little more to account for buffering.

player.seek(target_playout_pos +
client.kExpectedBufferTime *
client.kTimeToPosFactor)

### Clock Calculations

The client's synchronized clock object provides any of a variety of methods. An object can include LocalNow( ), which can return the current time according to the local system clock. Another object can include SynchronizedNow( ), which returns the current time according to the synchronized clock.

let synchronized_now ← clock. LocalNow( ) + clock.offset
return synchronized_now

Another object can include LocalToSynchronized( ), which returns the equivalent synchronized time given a local_time from the local system clock.

let synchronized_time ← local_time + clock.offset
return synchronzed_time

Another object can include SychronizedToLocal( ), which returns the equivalent local system clock time given a synchronized_time.

let local_time ← synchronized_time - clock.offset
return local_time

### Media Player

A compliant media player can provide any of the following services: seek to a specific position within the media stream, report the current position within the media stream, start playback, stop playback, report current playout state (ready to play, buffering, error) and notify when the state changes, and/or change playback rate as a multiple of the native playback rate.

### Content Delivery Network

The media source can provide both a playlist of streaming segments and the contents of the segments themselves. The media source can include mapping to segments as player implementation detail.

A compliant streaming source can have any of the following properties: segments have unique identifiers, segments report duration, variant video segments can be mapped to each other, and/or reports playback frame rate.

The content delivery network may include HLS. HTTP Live Streaming can be supported with no discontinuities and/or segment identifiers are consistent for all participants.

### Message Parameters

A message can include any of a variety of parameters. A parameter can include auth_token, which can include an authorization token permitting a client to join a Synchronization Group.

Another parameter can include group_id, where synchronization Groups are identified by the URI for the streaming media and a group identifier. The group identifier can be unique for each URI and will be known to participants using a mechanism of their choice.

Another parameter can include a URI, which can include the Uniform Resource Identifier for a particular stream.

Another parameter can include session_id, which can include a Unique identifier for a client participating in a Synchronization Group.

Another parameter can include event_id, which can include an Identifier for an event that must be acknowledged by clients, such as changing the base position in the media stream. Unique within a Synchronization Group.

Another parameter can include playout_target, which can include the position in the media stream that should be played out and the synchronized time that it should be played out at.

Another parameter can include playout_pos, which can include a playout position in the media stream.

Another parameter can include start_paused, which can include ff set to TRUE, then the Synchronization Group will initially transition to the PAUSE state. Otherwise it can initially transition to the PLAY state.

Another parameter can include min_playout_pos, which can include an earliest possible playout position.

Another parameter can include max_playout_pos, which can include a latest possible playout position.

Another parameter can include max_buffered_pos, which can include a latest possible playout position that has been buffered by the player.

Another parameter can include playout_bitrate, which can include a bitrate at which the media stream is currently being, or intended to be, downloaded.

Another parameter can include rtt, which can include an Estimated Round Trip Time between client and server.

### Operation Overview

An operation can include starting a Synchronization Group. This can include joining a Synchronization Group that doesn't exist yet.

For example, when C->S, a JOIN_REQUEST can include auth_token, group_id, uri, and/or start_paused. Playback Manager can request to join the synchronization session for {group_id, uri}. If the Synchronization Group does not currently exist, then it can be created.

The Coordination Server can download the playlist from the URI. The Coordination Server can:

Add new group to synchronization_groups
group.media_uri ← uni
group.group_id ← group_id
group.state ← START

For example, when S→C, a JOIN_REQUEST_ACK can include a session_id. Coordination Server can create a new Client object and respond with the client's session identifier. The Coordination Server can:

Add new client to group.clients
client.session_id ← session_id
client.last_ping_time ← group.clock .Now( )

This can continue the operation depending on start_paused.

Another operation can be when Synchronization Group is Initially Paused. If start_paused=TRUE then continue as follows:

If S→C, SEEK_PAUSE can include event_id, session_id, and/or playout_pos. The Coordination Server can tell the Playback Managers to get ready to play the first position in the streaming media.

### Coordination Server:

```
group.last_seek_pos ← First position in group.media_uri
group.last_seek_pos_event_id ← event_id
group.last_seek_pos_event_sent_time ←
group.clock .Now( )
group.state ← SEEK_PAUSE
For each client in group.clients:
    client.last_ack_seek_pos ← kNoPos
    client.last_seek_pos_ack_request_time ←
    group.clock .Now( )
playout_pos ← group.last_seek_pos
  If C → S, SEEK_PAUSE_ACK can include event_id and/or session_id.
```

The Playback Manager can wait until buffering is complete and then transition to the PLAY state.

### Coordination Server:

```
For client in clients where client.session_id =
session_id and group.last_seek_pos_event_id =
event_id
  client.last_seek_pos_ack_request_time ←
  group.clock.Now( )
  client.last_ack_seek_pos ←
  group.last_seek_pos
When group.IsDoneSeeking( ) = TRUE:
  group.state ← PAUSE
```

Another operation can include synchronization group is Initially Playing. If start_paused=FALSE then continue as follows:

When S→C, SEEK_PLAY can include event_id, session_id, playout_pos. The Coordination Server can tell the Playback Managers to get ready to play the first position in the streaming media.

### Coordination Server:

```
group.last_seek_pos ← First position in group.media_uri
group.last_seek_pos_event_id ← event_id
group.last_seek_pos_event_sent_time ←
group.clock .Now( )
group.state ← SEEK_PLAY
For each client in group.clients:
  client.last_ack_seek_pos ← kNoPos
  client.last_seek_pos_ack_request_time ←
  group.clock .Now( )
playout_pos ← group.last_seek_pos
```

When C→S, SEEK_PLAY_ACK can include Playback Manager waiting until buffering is complete and event_id session_id, and then reporting that it is ready to resume playback at the start time.

### Coordination Server:

```
If event_id = group.last_seek_pos_even_id :
  For client in group.clients where client.session_id
  = session_id:
    client.last_ack_seek_pos ←
    group.last_seek_pos
```

When S→C, PLAY can include session_id, playout_time, playout_pos. The Coordination Server can instruct clients to begin playback once all clients are ready to resume playback or once some clients are ready and the rest have timed out. The timeout is to prevent starvation if new clients are continually joining. Clients that time out can be resynced with UPDATE messages when they are ready to start playback.

In particular, the PLAY event can be sent when group.IsDoneSeeking( )=TRUE. The playout_time can be set to a point in the future that takes into account the time needed for the message to reach the client with the highest network delay.

### Coordination Server:

group.state = PLAY
group.base_time ← group.clock .Now( ) +
MAX( clients.client.rtt) * 2
playout_time ← group.last_seek_time
playout_pos ← group.last_seek_pos

Another operation can include joining a session in progress. When C->S, a JOIN_REQUEST can include auth_token, group_id, uri, start_paused. The Playback Manager can request to join the synchronization session for {group_id, uri}.

When S→C and JOIN_REQUEST_ACK, the Coordination Server can create a new Client object and session_id responds with the client's session identifier.

### Coordination Server:

Add new client to group.clients
client.session_id ← session_id
client.last_ping_time ← group.clock .Now( )

When S→C and SEEK_PLAY includes event_id, session_id, playout_pos, the Coordination Server can tell the client to prepare to play a playout position at point in the future when it expects the client will be ready.

### Coordination Server:

client.last_ack_seek_pos ← kNoPos
client.last_seek_pos_ack_request_time ←
group.clock .Now( )
playout_pos ← group.GetPlayoutTarget( ).pos +
(client.delay + kEstimatedSeekTime) *
kTimeToPosFactor
playout_pos ← MIN( playout_pos ,
client.max_playout_pos )
playout_pos ← MAX( playout_pos ,
client.min_playout_pos )

When C→S and SEEK_PLAY_ACK includes event_id and session_id, Playback Manager waits until buffering is complete and

then reports that it is ready to resume playback at the start time.

### Coordination Server:

```
If event_id = group.last_seek_pos_even_id :
For client in group.clients where client.session_id
= session_id:
  client.last_ack_seek_pos ←
  group.last_seek_pos
```

When S→C and PLAY includes session_id and playout_target, the Coordination Server can instruct the client to begin playback.

playout_target←group.GetPlayoutTarget( )

Another operation can include joining a paused session. When C->S and JOIN_REQUEST includes auth_token, group_id, uri, and start_paused, the Playback Manager can request to join the synchronization session for {group_id, uri}.

When S→C and JOIN_REQUEST_ACK includes session_id, Coordination Server can create a new Client object and respond with the client's session identifier.

### Coordination Server:

Add new client to group.clients
client.session_id ← session_id
client.last_ping_time ← group.clock .Now( )

When S→C and SEEK_PAUSE includes event_id, session_id, and playout_pos, the Coordination Server can tell the client to prepare to play at the last seek position, which is the position that the other clients have been told to hold at.

### Coordination Server:

client.last_ack_seek_pos ← kNoPos
client.last_seek_pos_ack_request_time ←
group.clock .Now( )
client.event_id ← event_id
playout_pos ← group.last_seek_pos

When C→S and SEEK_PAUSE_ACK includes event_id and session_id, the Playback Manager can wait until buffering is complete and then reports that it is ready to resume playback at the start time.

### Coordination Server:

```
If event_id = group.last_seek_pos_even_id :
  For client in group.clients where client.session_id
  = session_id:
    client.last_ack_seek_pos ←
    group.last_seek_pos
```

Another operation can include rejoining a session with an expired session_id. When C->S and REJOIN_REJECT includes auth_token and session_id, the Playback Manager can request to join the synchronization session for {group_id, uri}.

When S→C and REJOIN_REJECT_NACK includes session_id, the Coordination Server may fail to find the client object matching session_id and report the error. The Playback Manager can proceed to join as a new client using a JOIN message.

Another operation can include rejoining with an active session_id. When C->S and REJOIN REQUEST includes auth_token and session_id, the Playback Manager can request to join the synchronization session for {group_id, uri}. Coordination Server can find the client object matching session_id.

### Coordination Server:

client.last_ping_time ← group.clock . Now( )

Another operation can include periodic synchronization that includes the Playback Managers and Coordination Servers periodically send each other playback state information.

The playback manager can report a current playback state. Playback Managers can periodically report their playback state every client.kMinUpdateInterval. No updates are sent if client.state !=PLAY.

When C→S and CLIENT_REPORT includes session_id, playout_time, playout_pos, min_playout_pos, max_playout_pos, max_buffered_pos, playout_bitrate, rtt, the playback manager can report its current playback state.

### Playback Manager:

session_id ← client.session_id
playout_time ← client.clock. SynchronizedNow( )
playout_pos ← clientplayer. CurrentPos ( )
min_payout_pos ← client.player. MinPlayoutPos ( )
max_payout_pos ← clientplayer. MinPlayoutPos ( )
playout_bitrate ← clientplayer. PlayoutBitrate ( )
rtt ← client.rtt

### Coordination Server:

```
For client in group.clients where client.session_id =
session_id :
  client.playout_time = playout_time
  client.playout_pos = playout_pos
  client.min_playout_pos = min_playout_pos
  client.max_playout_pos = max_playout_pos
  client.max_buffered_pos =
  max_buffered_pos
  client.playout_bitrate = playout_bitrate
  client.last_playout_pos_update =
  group.clock .Now( )
  client.rtt = rtt
```

The Coordination Server can Update the Playout Target by periodically sending the playout target every group.kMinUpdateInterval. No updates are sent if group.state!=PLAY or if clock.Now( )<group.base_pos_time.

When S→C and UPDATE includes session_id and playout_target, Coordination Server generates UPDATE messages with the server time and playback position.

### Coordination Server:

playout_target ← group.GetPlayoutTarget( )
For each client in group.clients :
session_id ← client.session_id

The Playback Manager can compare its current playback position to the expected playback position and may adjust playback parameters.

### PlaybackManager:

client.UpdatePlayback( playout_target )

A seek request can move forward or backward to a position in the media stream, by client request. When C→S and SEEK_REQUEST includes session_id and playout_pos, request that the synchronization session change the playout position.

### Coordination Server:

group.last_seek_pos ← playout_pos

A seek request while playing can be if group.state=SEEK_PLAY or group.state=PLAY. S→C and SEEK_PLAY includes event_id, session_id, and playout_pos, Coordination Server can tell the Playback Managers to get ready to play the requested position in the streaming media.

### Coordination Server:

```
group.last_seek_pos_event_id ←
group.last_seek_pos_event_id + 1
group.last_seek_pos_event_sent_time ←
group.clock. Now( )
group.state ← SEEK_PLAY
For each client in group.clients :
  client.last_base_pos_ack_request_time ←
  group.clock. Now( )
playout_pos ← group.last_seek_pos
```

When C→S and SEEK_PLAY_ACK includes event_id and session_id, Playback Manager can wait until buffering is complete and then reports that it is ready to resume playback at the start time.

### Coordination Server:

```
If event_id = group.last seek_pos even id:
For client in group.clients where client.session_id =
session_id:
  client.last_ack_seek_pos ←
  group.last_seek_pos
```

When S→C and PLAY includes session_id and playout_target, the Coordination Server can instruct clients to begin playback once all clients are ready to resume playback or once some clients are ready and the rest have timed out. The timeout is to prevent starvation if new clients are continually joining. Clients that time out will be resynced with UPDATE messages when they are ready to start playback.

In particular, the PLAY event will be sent when group.IsDoneSeeking( )=TRUE.

The playout time will be set to a point in the future that takes into account the time needed for the message to reach the client with the highest network delay.

### Coordination Server:

group.state = PLAY
group.base time ← group.clock.Now() +
MAX( clients.client.rtt ) * 2
playout_target.time ← group.base_time
playout_target.pos ← group.base_pos

A Seek Request While Paused can be when group.state=SEEK_PAUSE or group.state=PAUSE.

When S→C and SEEK_PAUSE includes event_id, session_id, and playout_pos, Coordination Server tells the Playback Managers to get ready to play the requested position in the streaming media.

### Coordination Server:

```
group.last_seek_pos_event_id ←
group.last_seek_pos_event_id + 1
group.base_pos_event_sent_time ← group.clock. Now()
group.state ← SEEK_PAUSE
For each client in group.clients :
  client.last_seek_pos_ack_request_time ←
  group.clock. Now()
playout_pos ← group.last_seek_pos
```

When C→S and SEEK_PAUSE_ACK includes event_id and session_id, Playback Manager waits until buffering is complete and then holds the clients at that playback position.

### Coordination Server:

```
If event_id = group.last_seek_pos_event_id :
For client in group.clients where client.session_id =
session_id:
  client.last_ack_seek_pos ←
  group.last_seek_pos
If group.IsDoneSeeking() then
  group.state ← PAUSE
```

A Pause Request can include holding on a position in the media stream, by client request. When C→S and PAUSE_REQUEST includes session_id, request that the synchronization session stop playout.

### Coordination Server:

group.last_seek_pos←group. GetTargetPlayout( ).pos

When S→C and SEEK_PAUSE includes event_id, session_id, and playout_pos, Coordination Server tells the Playback Managers to get ready to play the requested position in the streaming media.

### Coordination Server:

```
group.base_pos_event_id ← group.base_pos_event_id + 1
group.base_pos_event_sent_time ← group.clock .Now()
group.state ← SEEK_PAUSE
For each client in group.clients :
  client.last_seek_pos_ack_request_time ←
  group.clock .Now()
playout_pos ← group.last_seek_pos
```

When C→S and SEEK_PAUSE_ACK includes event_id and session_id, Playback Manager waits until buffering is complete and then holds the clients at that playback position.

### Coordination Server:

```
If event_id = group.last_seek_pos_event_id :
  For client in group.clients where client.session_id =
  session_id:
    client.last_ack_seek_pos ←
    group.last_seek_pos
If group.IsDoneSeeking() then
  group.state ← PAUSE
```

A play operation can include resuming playback, by client request. When C→S and PLAY_REQUEST includes session_id, request that the synchronization session resume playout. The request is ignored unless the Coordination Server is in PAUSE or SEEK_PAUSE state.

When S→C and PLAY includes session_id and playout_target, the Coordination Server can instruct clients to begin playback once all clients are ready to resume playback or once some clients are ready and the rest have timed out. The timeout is to prevent starvation if new clients are continually joining. Clients that time out will be resynced with UPDATE messages when they are ready to start playback.

In particular, the PLAY event will be sent when group.IsDoneSeeking( )=TRUE. The playout_time may be set to a point in the future that takes into account the time needed for the message to reach the client with the highest network delay.

### Coordination Server:

group.state = PLAY
group.last_seek_time ← group.clock .Now() +
MAX( clients.client.rtt ) * 2
playout_target.time ← group.last_seek_time
playout_target.pos ← group.last_seek_pos

A client may quit session when the client requests to leave a synchronization group. When C→S and QUIT includes session_id, Playback Manager requests to leave the synchronization group.

When S→C and QUIT_ACK includes session_id, coordination Server acknowledges that the Playback Manager is no longer a member of the synchronization session.

### Coordination Server:

Remove client with session_id from group.clients

There may be additional actions depending on the Coordination Server state, as described in the following sections.

If the last session quits and if group.clients is empty, then remove group from coordinator.groups and free its resources.

Another operation can include quitting a Running Synchronization Group. If group.state=PLAY, then continue as follows. When S→C and UPDATE includes session_id and playout_target, Coordination Server recalculates the playout target and notifies the remaining clients.

### Coordination Server:

```
For each client in group.clients :
  session_id ← client.session_id
  playout_target ← group.GetPlayoutTarget ()
```

Another operation can include Quit a Seeking Synchronization Group Waiting on the Client. If group.state=PLAY_SEEK and group.IsDoneSeeking( ), then continue as follows. When S→C and PLAY includes session_id and playout_target, Coordination Server instructs the remaining clients to start playing, choosing a time in the future by which all clients should have received the notification.

### Coordination Server:

group.last_seek_time ← group.clock. Now() +
MAX( group.clients.rtt ) * 2
playout_target.time ← group.last_seek_time
playout_target.pos ← group.last_seek_pos
For each client in group.clients:
session_id ← client.session_id

Another operation can include Quit a Pausing Synchronization Group Waiting on the Client. If group.state=PAUSE_SEEK and group.IsDoneSeeking( ), then transition by setting group.state←PAUSE.

### Clock Synchronization

To maintain synchronization, all participants in a synchronization session may synchronize their clocks. In this way, the Coordination Server and Playback Managers will all have the same understanding of target playout times. The server periodically sends timing information to the clients to keep their clocks in sync. This exchange is also used as keepalives (e.g., to verify that clients are still connected and responsive).

Clock synchronization is derived independently by each Playback Manager using an algorithm such as Cristian's Algorithm, for example. Each Playback Manager exchanges messages with the Coordination Server to implement a simplified version the algorithm as follows:

When C→S and CLOCK_SYNC_REQUEST includes session_id and clock_sync_tc0, Playback Manager requests that the Synchronization Server respond with its current timing information. The Synchronization Server records the time that the message arrived.

### Playback Manager:

```
clock_sync_tc0 ← clock. LocalNow ()
Coordination Server:
For client in group.clients where client.session_id =
session_id :
  client.last_clock_sync_tc0 ← clock_sync_tc0
  client.last_clock_sync_ts1 ← group. clock .Now()
```

When S→C and CLOCK_SYNC_RESPONSE includes session_id, clock_sync_tc0, clock_sync_ts1, and clock_sync_ts2, Coordination Server sends a response to the Playback Manager. The Playback Manager calculates the round trip time from the timestamps in the message and uses it to calculate an offset value to convert between local and server timestamps, using the assumption that network delay is the same in both directions.

### Coordination Server:

clock_sync_tc0 ← client.last_clock_sync_tc0
clock_sync_ts1 ← client.last_clock_sync_ts1
clock_sync_ts2 ← group.clock. Now()

### Playback Manager:

clock_sync_tc3 ← clock. LocalNow()
clock.rtt ← ( clock_sync_tc3 - clock_sync_tc0) -
(clock_sync_ts2 - clock_sync_ts1)
let delay ← clock.rtt / 2
clock_sync_ts0 ← clock_sync_ts1 - delay
clock.offset ← clock_sync_ts0 - clock_sync_tc0

When a Client Times Out, for any client in group.clients where group.clock.Now( )-client.last_ping_time)>kTimeoutThreshold, the system may proceed as if the Coordination Server received a QUIT message with session_id=client.session_id, as described in the section Client Quits a Session.

Handling Changing Playlist Contents can include the Coordination Server downloading the playlist frequently enough to pick up changes. When C→S and PLAYLIST_UPDATE includes session_id, min_playout_pos, and max_playout_pos, when client.player reports that it has updated its playlist, then the Playback Manager reports its new minimum and maximum playout positions.

### Playback Manager:

session_id ← client.session_id
min_payout_pos ← client.player.MinPlayoutPos()
max_payout_pos ← client.player.MinPlayoutPos()

### Coordination Server:

For client in group.clients where client.session_id =
session_id :
client.min_playout_pos = min_playout_pos
client.max_playout_pos = max_playout_pos

The Coordination Server can then send an additional UPDATE notification as per Periodic Synchronization.

### Interface Overview

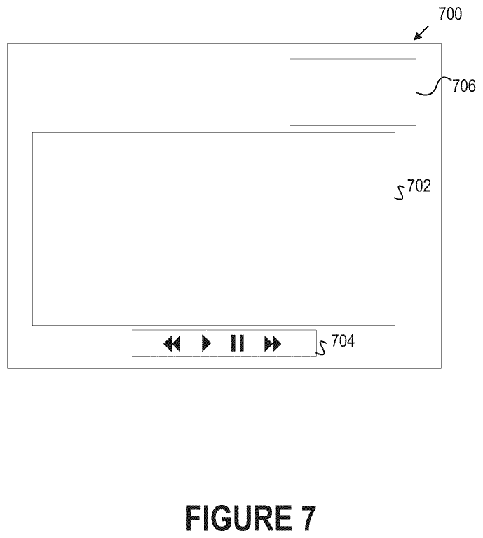

The media content stream as described herein can be rendered and outputted on an interface. The interface can include a player executing on each participant device. FIG. 7 illustrates an example interface 700 capable of being executed on a participant device.

As shown in FIG. 7, the interface 700 can include a display 702. The display 702 can include a portion of the interface 700 outputting the media content stream. The interface 700 can also include a series of buttons 704. Each button 704 can modify various settings or a state of playback of the media content stream. For instance, a play button can instruct the synchronization server to begin playback of synchronized media content on the interface 700.

In some embodiments, the interface 700 can include a secondary display 706. The secondary display 706 can include a portion of the interface 700 capable of playing media other than the media content stream playing on the display 702. For instance, the secondary display 706 can playback video captured on cameras on various participant devices to capture video indicative of the participants watching the media content stream. In other words, the secondary display 706 can output video depicting participants. The secondary video outputting on secondary display 706 can be synchronized using techniques as described herein. repla

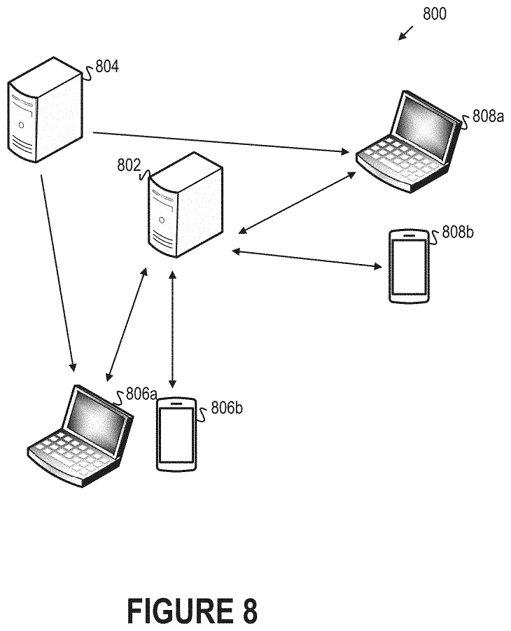

In some embodiments, multiple devices associated with each participant can be utilized in playback of multiple types of media in a synchronized manner. FIG. 8 is a block diagram of an example network 800 depicting multiple devices associated with each participant.

As shown in FIG. 8, the network 800 can include a coordination server 802. The coordination server 802 can synchronize playback of media content, as described herein. The network 800 can include a content delivery node 804 configured to deliver media content (e.g., video, audio, a sports broadcast, a movie) to participant devices.

The network 800 can include devices associated with a participant. For instance, a first participant can be associated with a first participant device 806a and a second participant device 806b, and a second participant can be associated with a first participant device 808a and a second participant device 808b. The first participant devices 806a, 808a can be electronic devices (e.g., a computer) configured to output the media content stream in a synchronized manner as described herein.

The second participant devices 806b, 808b can include electronic devices (e.g., a smart phone) configured to facilitate communication between participants. For example, second participant devices 806b, 808b can initiate a video call or audio call between participants that enables audio/video interaction between participants. The participants on second participant devices 806b, 808b can provide reactions or commentary on the media content stream as the media content stream is played back. The video/audio communication between second participant devices 806b, 808b can be synchronized using the coordination server 802 to synchronize playback of the video/audio communication using techniques as described herein.

### Live Streams

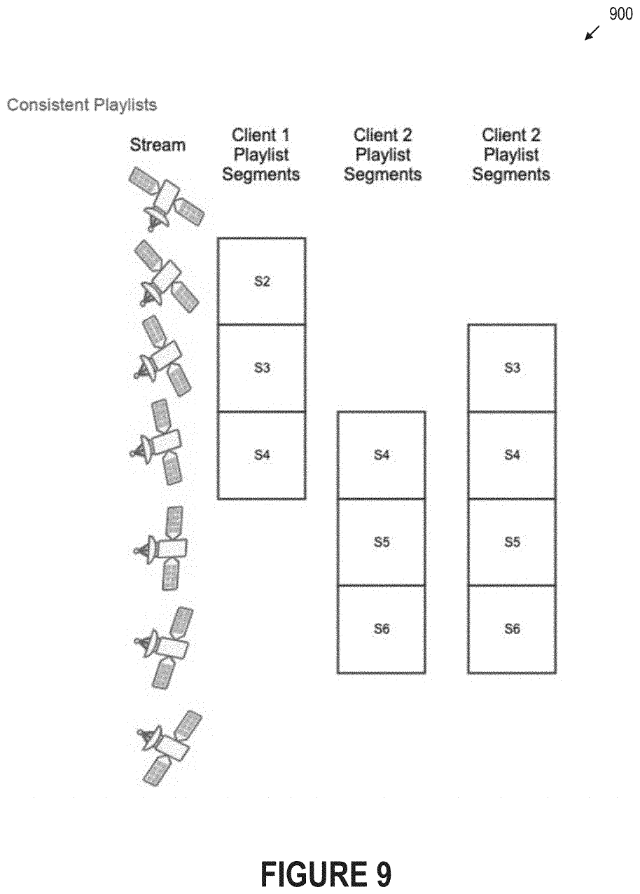

Clients may join a live stream in progress at different times, potentially resulting in different minimum and maximum playout positions. FIG. 9 is an example block diagram 900 depicting multiple clients with playlist segments associated with various streams.

As long as each client's playlists use a consistent way to identify position then PLAYLIST_UPDATE notifications are sufficient for the Coordination Server to maintain the playout position within the bounds of all of the participants, i.e., MAX(clients.min_playout_pos)<=target playout position<=MIN(clients.max_playout_pos).

If a Player reports that it has begun playing out at a discontinuity, for example when it begins to play an inserted ad, then the Playback Manager can QUIT the Synchronization Group.

### Example Method for Synchronization of Media Content Across Participant Devices

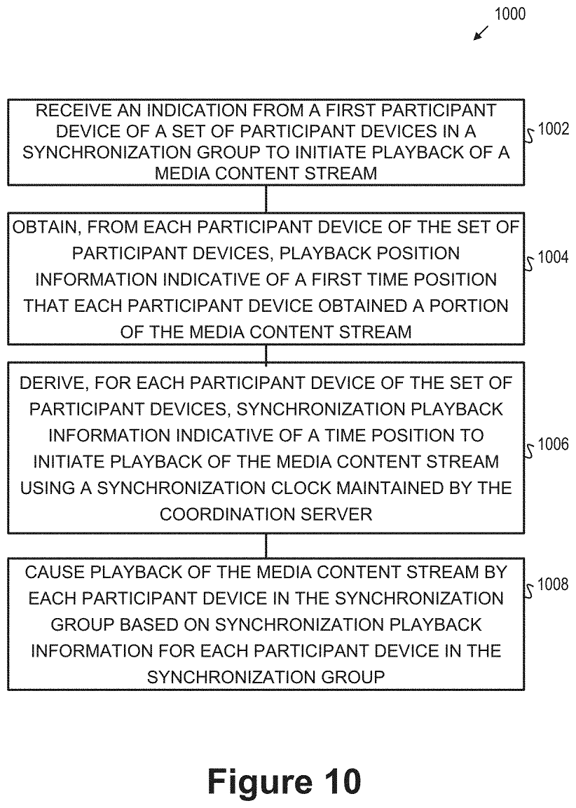

FIG. 10 is a block diagram of an example method 1000 for synchronization of media content between participant devices. The method can include receiving an indication from a first participant device of a set of participant devices to initiate playback of a media content stream (block 1002). Each of the set of participant devices can be part of a synchronization group configured to simultaneously playback the media content.

The method can include obtaining, from each participant device of the set of participant devices, playback position information indicative of a time position that each participant device obtained a portion of the media content (block 1004). As noted above, the playback position of each participant device can differ from other participant devices for various reasons (e.g., network speeds, broadcast server speeds, offset times provided by broadcast server).

The method can include deriving, for each participant device of the set of participant devices, synchronization playback information indicative of a time position to initiate playback of the media content stream using a synchronization clock maintained by the coordination server (block 1006). This can include calculating a common time position that each participant device can begin playback of the media content such that a portion media content is buffered by each player. The synchronization playback information can incorporate an offset of the playback position information of each participant device relative to playback position information obtained for other participant devices in the synchronization group.

The method can include causing playback of the media content stream by each participant device in the synchronization group based on synchronization playback information for each participant device in the synchronization group (block 1008). The participant devices can utilize the synchronization time and the synchronization clock of the coordination server to simultaneously playback the media content.

In some embodiments, the method can include distributing an authorization token to each participant device in the set of participant devices. Each authorization token can include a unique client session identifier identifying the media content stream between the participant devices. The method can also include obtaining a request to join the media content stream from the first participant device of the set of participant devices in the synchronization group, the request including the authorization token. Responsive to obtaining the request to join the media content stream from the first participant device, the method can include identifying the media content stream between the participant devices based on the unique client session identifier identified in the authentication token. The method can include adding the first participant device to the synchronization group based on identifying the media content stream between the participant devices from the authentication token provided by the first participant device.

In some embodiments, the method can include obtaining updated playback position information from each participant device of the set of participant devices. The method can also include deriving, for each participant device of the set of participant devices, updated synchronization playback information indicative of an updated time position to playback the media content stream at a second time position using the synchronization clock, each participant device configured to update playback of the media content stream based on the updated synchronization playback information.

In some embodiments, the media content stream can be played on a media player application executing on each participant device in the synchronization group, and wherein each participant device is configured to subscribe to and retrieve a unique instance of the media content stream from a content delivery node.

In some embodiments, the method includes detecting a state change request to modify a state of playback of the media content stream from any participant device in the synchronization group. The state of playback can include any of a play state, a pause state, a stop state, a fast-forward state, and a rewind state. The method can also include responsive to detecting the state change request, causing modification of playback on each participant device according to the state of playback to be modified in the state change request.

In some embodiments, the method can include determining, at a first time, that a network bandwidth of a second participant device in the synchronization group falls below a threshold network bandwidth level. The method can also include stopping playback of the media content stream for all participant devices in the synchronization group. The method can also include determining, at a second time, that the network bandwidth of the second participant device in the synchronization group exceeds the threshold network bandwidth level. The method can also include, responsive to determining that the network bandwidth of the second participant device exceeds the threshold network bandwidth level, causing playback of the media content stream to resume on each participant device in the synchronization group.

In some embodiments, the method includes causing playback of advertising content on all participant devices in the synchronization group other than the second participant device according to the synchronization playback information. The method can also include stopping playback of the advertising content responsive to determining that the network bandwidth of the second participant device exceeds the threshold network bandwidth level.

In some embodiments, the method includes causing playback of the media content stream by each participant device in the synchronization group includes causing display of video associated with the media content stream on a first portion of a display of each participant device. This can also include causing display of video captured on a camera associated with each participant device on a second portion of the display of each participant device, each participant device configured to output audio from both the media content stream and from audio components on each participant device.

In some embodiments, the method includes obtaining, from each participant device of the set of participant devices, secondary playback information that includes audio and video data captured by sensors of each secondary participant device associated with each participant that is part of the synchronization group. The secondary participant device can be paired with the participant device in the synchronization group. The method can also include obtaining the secondary playback information from the secondary participant device. The method can also include deriving, for each participant device of the set of participant devices, secondary synchronization playback information indicative of a time position to initiate playback of the secondary playback information on each secondary participant device using the synchronization clock. The method can also include causing playback of the secondary playback information on each secondary participant device according to the secondary synchronization playback information, wherein playback of the secondary playback information corresponds to playback of the media content stream on the participant devices. The method can also include causing playback of the secondary playback information on the participant devices, such as on a second portion of a display of the participant device while the media content stream plays on a first portion of the display.

The present embodiments can relate to a system to playback synchronized media content between participant devices included in a synchronization group. The system can include a coordination server. The coordination server can be configured to receive an indication to initiate playback of a media content stream across a set of participant devices part of a synchronization group configured to simultaneously playback the media content stream. The coordination server can also be configured to obtain playback position information indicative of a first time position that each participant device obtained a portion of the media content stream. The coordination server can also be configured to derive synchronization playback information unique to each participant device to synchronize playback of the media content stream using a synchronization clock.

The system can include a first participant device included in the synchronization group. The first participant device can be configured to obtain the media content stream from a content delivery node, wherein each participant device in the synchronization group is configured to separately obtain the media content stream from the content delivery node. The first participant device can also be configured to receive the synchronization playback information specific to the first participant device from the coordination server. The first participant device can also be configured to playback the media content stream via a player executing on the first participant device according to the synchronization playback information specific to the first participant device.

In some embodiments, the coordination server can be further configured to distribute an authorization token to each participant device in the set of participant devices, each authorization token including a unique client session identifier identifying the media content stream between the set of participant devices. The coordination server can also be configured to obtain a request to join the media content stream from the first participant device, the request including the authorization token. The coordination server can also be configured to responsive to obtaining the request to join the media content stream from the first participant device, identify the media content stream between the participant devices based on the unique client session identifier identified in the authentication token. The coordination server can also be configured to add the first participant device to the synchronization group based on identifying the media content stream between the participant devices from the authentication token provided by the first participant device.

In some embodiments, the coordination server can be further configured to detect a state change request to modify a state of playback of the media content stream from any participant device in the synchronization group, the state of playback including any of a play state, a pause state, a stop state, a fast-forward state, and a rewind state. The coordination server can also be configured to responsive to detecting the state change request, cause modification of playback on each participant device according to the state of playback to be modified in the state change request.

In some embodiments, the coordination server can be further configured to determine, at a first time, that a network bandwidth of the first participant device in the synchronization group falls below a threshold network bandwidth level. The coordination server can also be configured to stop playback of the media content stream for all participant devices in the synchronization group. The coordination server can also be configured to determine, at a second time, that the network bandwidth of the first participant device in the synchronization group exceeds the threshold network bandwidth level. The coordination server can also be configured to responsive to determining that the network bandwidth of the first participant device exceeds the threshold network bandwidth level, cause playback of the media content stream to resume on each participant device in the synchronization group.

In some embodiments, the coordination server can be further configured to cause playback of advertising content on all participant devices in the synchronization group other than the first participant device according to the synchronization playback information. The coordination server can also be configured to stop playback of the advertising content responsive to determining that the network bandwidth of the first participant device exceeds the threshold network bandwidth level.

In some embodiments, the first participant device can be further configured to output the media content stream on a first portion of a display on the player. The first participant device can also be configured to output a video captured on a camera associated with each participant device on a second portion of the display on the player, each participant device configured to output audio from both the media content stream and from audio components on each participant device.

In some embodiments, a method performed by a participant device to playback media content in a synchronized manner among participant devices included in a synchronization group can include sending a request to a content delivery node to receive a stream of data representative of media content to be simultaneously played back to each participant device of the set of participant devices included in a synchronization group. The method can also include obtaining the stream of data representative of the media content from the content delivery node. The method can also include determining a time position that the participant device reached a playback position in a first portion of the media content. The method can also include sending the time position to a coordination node configured to synchronize playback of the media content across each participant device of the set of participant devices included in the synchronization group. The method can also include receiving a synchronization time from the coordination server, the synchronization time indicative of a time position to initiate playback of the media content using a synchronized clock maintained by the coordination server. The method can also include outputting the media content according to the synchronization time provided by the coordination server.

In some embodiments, a method to implement both synchronized playback of media content and direct communication among participants included in a synchronization group can include sending, by a first participant device associated with a participant included in a synchronization group, a request to a content delivery node to receive a stream of data representative of media content to be simultaneously played back to each participant included in the synchronization group, wherein the first participant device is included in a first set of devices associated with each participant included in the synchronization group. The method can also include obtaining, by the first participant device, the stream of data representative of the media content from the content delivery node. The method can also include initiating, by a second participant device associated with the participant, a communication interface between each a second set of devices associated with each participant included in the synchronization group to facilitate communication between each participant included in the synchronization group. The method can also include determining, by the first participant device, a time position that the participant device reached a playback position in a first portion of the media content. The method can also include sending, by the first participant device, the time position to a coordination node configured to synchronize playback of the media content across each participant device of the set of participant devices included in the synchronization group. The method can also include receiving, by the first participant device, a synchronization time from the coordination server, the synchronization time indicative of a time position to initiate playback of the media content using a synchronized clock maintained by the coordination server. The method can also include outputting, by the first participant device, the media content according to the synchronization time provided by the coordination server.

In some embodiments, a method performed by a coordination server for synchronizing playback of media content that includes advertising content among participant devices included in a synchronization group can include receiving an indication from a first participant device of a set of participant devices to initiate playback of media content from a content delivery node, each of the set of participant devices part of a synchronization group configured to simultaneously playback the media content. The method can also include obtaining, from each participant device of the set of participant devices, playback position information indicative of a time position that each participant device obtained a portion of the media content. The method can also include deriving a synchronization time indicative of a time position to initiate playback of the media content using a synchronized clock maintained by the coordination server. The method can also include determining that a second participant device of the set of participant devices includes a network connectivity quality that falls below a threshold. The method can also include responsive to determining that the second participant device includes the network connectivity quality that falls below the threshold, retrieving advertising content to be played back by the set of participant devices. The method can also include instructing each participant device of the set of participant devices except for the second participant device to playback advertising content retrieved by the coordination server.

In some embodiments, the method can include determining that the second participant device includes a new network connectivity quality that exceeds a threshold. The method can also include responsive to determining that the second participant device includes the new network connectivity quality that exceeds the threshold, instructing each participant device of the set of participant devices to playback the media content according to the synchronization time.

In some embodiments, a method performed by a coordination server for synchronizing playback of media content among participant devices included in a synchronization group and resynchronizing playback after an advertisement portion of the media content can include receiving an indication from a first participant device of a set of participant devices to initiate playback of media content from a content delivery node, each of the set of participant devices part of a synchronization group configured to simultaneously playback the media content. The method can also include obtaining, from each participant device of the set of participant devices, playback position information indicative of a time position that each participant device obtained a portion of the media content. The method can also include deriving a synchronization time indicative of a time position to initiate playback of the media content using a synchronized clock maintained by the coordination server. The method can also include instructing each participant device of the set of participant devices to playback the media content according to the synchronization time. The method can also include determining whether the media content is representative of one of active content or advertising content. The method can also include, responsive to determining that the media content is representative of advertising content, identifying a transition from the advertising content to the active content. The method can also include obtaining, from each participant device of the set of participant devices, a new playback position information indicative of a new time position that each participant device has obtained a new portion of the media content. The method can also include deriving a new synchronization time indicative when to initiate playback of the media content using the synchronized clock. The method can also include instructing each participant device of the set of participant devices to playback the media content according to the new synchronization time.

### Example Processing System

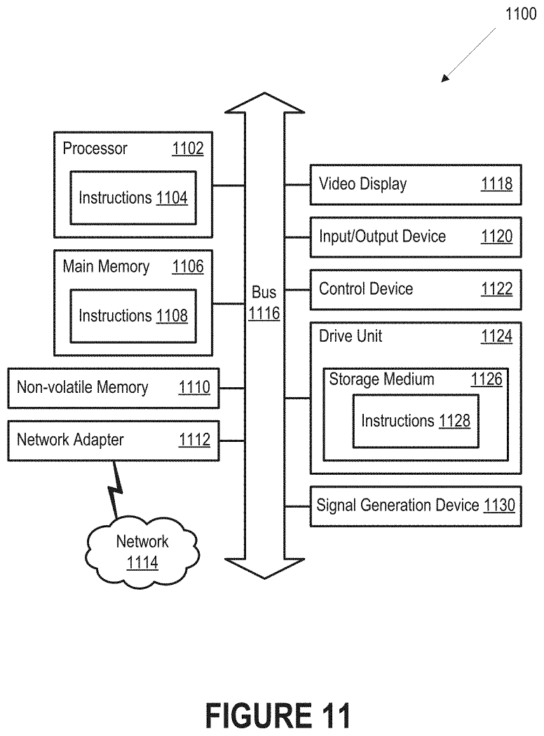

FIG. 11 is a block diagram illustrating an example of a processing system 1100 in which at least some operations described herein can be implemented. For example, some components of the processing system 1100 may be hosted on an electronic device that includes a participant device or a coordination server as described here.

The processing system 1100 may include one or more central processing units (“processors”) 1102, main memory 1106, non-volatile memory 1110, network adapter 1112 (e.g., network interface), video display 1118, input/output devices 1120, control device 1122 (e.g., keyboard and pointing devices), drive unit 1124 including a storage medium 1126, and signal generation device 1130 that are communicatively connected to a bus 1116. The bus 1116 is illustrated as an abstraction that represents one or more physical buses and/or point-to-point connections that are connected by appropriate bridges, adapters, or controllers. The bus 1116, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1100 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1100.

While the main memory 1106, non-volatile memory 1110, and storage medium 1126 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the processing system 1100.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in a computing device. When read and executed by the one or more processors 1102, the instruction(s) cause the processing system 1100 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1110, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1112 enables the processing system 1100 to mediate data in a network 1114 with an entity that is external to the processing system 1100 through any communication protocol supported by the processing system 1100 and the external entity. The network adapter 1112 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1112 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following embodiments.

What is claimed is:

1. A method performed by a coordination server for synchronizing playback of a media content stream between participant devices included in a synchronization group, the method comprising:
receiving an indication from a first participant device of a set of participant devices in a synchronization group to initiate playback of the media content stream, each of the set of participant devices in the synchronization group configured to simultaneously playback the media content stream;
obtaining, from each participant device of the set of participant devices, playback position information indicative of a first time position that each participant device obtained a portion of the media content stream;
deriving, for each participant device of the set of participant devices, synchronization playback information indicative of a second time position to initiate playback of the media content stream using a synchronization clock maintained by the coordination server, the synchronization playback information incorporating an offset of the playback position information of each participant device relative to playback position information obtained for other participant devices in the synchronization group; and
causing playback of the media content stream by each participant device in the synchronization group based on the synchronization playback information for each participant device in the synchronization group.

2. The method of claim 1, further comprising:
distributing an authorization token to each participant device in the set of participant devices, each authorization token including a unique client session identifier identifying the media content stream;
obtaining a request to join the media content stream from the first participant device of the set of participant devices in the synchronization group, the request including the authorization token;
responsive to obtaining the request to join the media content stream from the first participant device, identifying the media content stream based on the unique client session identifier identified in the authorization token; and
adding the first participant device to the synchronization group based on identifying the media content stream from the authorization token provided by the first participant device.

3. The method of claim 1, further comprising:
obtaining updated playback position information from each participant device of the set of participant devices;
deriving, for each participant device of the set of participant devices, updated synchronization playback information indicative of an updated second time position to playback the media content stream using the synchronization clock, each participant device configured to update playback of the media content stream based on the updated synchronization playback information.

4. The method of claim 1, wherein the media content stream is played on a media player application executing on each participant device in the synchronization group, and wherein each participant device is configured to subscribe to and retrieve a unique instance of the media content stream from a content delivery node.

5. The method of claim 1, further comprising:
detecting a state change request to modify a state of playback of the media content stream from any participant device in the synchronization group, the state of playback including any of a play state, a pause state, a stop state, a fast-forward state, or a rewind state;
responsive to detecting the state change request, causing modification of playback on each participant device according to the state of playback to be modified in the state change request.

6. The method of claim 1, further comprising:
determining, at a first time, that a network bandwidth of a second participant device in the synchronization group falls below a threshold network bandwidth level;
stopping playback of the media content stream for all participant devices in the synchronization group;
determining, at a second time, that the network bandwidth of the second participant device in the synchronization group exceeds the threshold network bandwidth level;
responsive to determining that the network bandwidth of the second participant device exceeds the threshold network bandwidth level, causing playback of the media content stream to resume on each participant device in the synchronization group.

7. The method of claim 6, further comprising:
causing playback of advertising content on all participant devices in the synchronization group other than the second participant device according to the synchronization playback information; and
stopping playback of the advertising content responsive to determining that the network bandwidth of the second participant device exceeds the threshold network bandwidth level.

8. The method of claim 1, wherein causing playback of the media content stream by each participant device in the synchronization group further comprises:
causing display of video associated with the media content stream on a first portion of a display of each participant device; and
causing display of video captured on a camera associated with each participant device on a second portion of the display of each participant device, each participant device configured to output audio from both the media content stream and from audio components on each participant device.

9. The method of claim 1, further comprising:
obtaining, from a plurality of secondary participant devices, secondary playback information that includes audio and video data captured by sensors of each secondary participant device;
wherein each secondary participant device is associated with a participant device in the synchronization group;
deriving, for each secondary participant device, secondary synchronization playback information indicative of a third time position to initiate playback of the secondary playback information on each secondary participant device using the synchronization clock; and
causing playback of the secondary playback information on each secondary participant device according to the secondary synchronization playback information, wherein playback of the secondary playback information corresponds to playback of the media content stream on the participant devices in the synchronization group.

10. The method of claim 1, wherein the synchronization playback information of each participant device further incorporates a weight associated with the playback position information.

11. The method of claim 10, wherein the weight is based on at least one of: a bitrate of the media content stream, the first time position, or a remaining buffer.

12. A system to playback synchronized media content between participant devices included in a synchronization group, the system comprising:
a coordination server configured to:
receive an indication to initiate playback of a media content stream across a set of participant devices part of a synchronization group configured to simultaneously playback the media content stream;
obtain playback position information indicative of a first time position that each participant device obtained a portion of the media content stream; and
derive synchronization playback information unique to each participant device to synchronize playback of the media content stream using a synchronization clock; and
a first participant device included in the synchronization group configured to:
obtain the media content stream from a content delivery node, wherein each participant device in the synchronization group is configured to separately obtain the media content stream from the content delivery node;
receive the synchronization playback information specific to the first participant device from the coordination server; and
playback the media content stream via a player executing on the first participant device according to the synchronization playback information specific to the first participant device.

13. The system of claim 12, wherein the coordination server is further configured to:
distribute an authorization token to each participant device in the set of participant devices, each authorization token including a unique client session identifier identifying the media content stream;
obtain a request to join the media content stream from the first participant device, the request including the authorization token;
responsive to obtaining the request to join the media content stream from the first participant device, identify the media content stream based on the unique client session identifier identified in the authorization token; and
add the first participant device to the synchronization group based on identifying the media content stream from the authorization token provided by the first participant device.

14. The system of claim 12, wherein the coordination server is further configured to:
detect a state change request to modify a state of playback of the media content stream from any participant device in the synchronization group, the state of playback including any of a play state, a pause state, a stop state, a fast-forward state, and a rewind state;
responsive to detecting the state change request, cause modification of playback on each participant device according to the state of playback to be modified in the state change request.

15. The system of claim 12, wherein the coordination server is further configured to:
determine, at a first time, that a network bandwidth of the first participant device in the synchronization group falls below a threshold network bandwidth level;
stop playback of the media content stream for all participant devices in the synchronization group;
determine, at a second time, that the network bandwidth of the first participant device in the synchronization group exceeds the threshold network bandwidth level;
responsive to determining that the network bandwidth of the first participant device exceeds the threshold network bandwidth level, cause playback of the media content stream to resume on each participant device in the synchronization group.

16. The system of claim 15, wherein the coordination server is further configured to:
cause playback of advertising content on all participant devices in the synchronization group other than the first participant device according to the synchronization playback information; and
stop playback of the advertising content responsive to determining that the network bandwidth of the first participant device exceeds the threshold network bandwidth level.

17. The system of claim 12, wherein the first participant device is further configured to:
output the media content stream on a first portion of a display on the player; and
output a video captured on a camera associated with each participant device on a second portion of the display on the player, each participant device configured to output audio from both the media content stream and from audio components on each participant device.

18. A non-transitory machine-readable medium having machine executable instructions stored thereon that, when executed by one or more processors, direct the one or more processors to perform a method comprising:
receiving an indication from a first participant device of a set of participant devices in a synchronization group to initiate playback of a media content stream, each of the set of participant devices part of a synchronization group configured to simultaneously playback the media content stream;
obtaining, from each participant device of the set of participant devices, playback position information indicative of a first time position that each participant device obtained a portion of the media content stream;
deriving, for each participant device of the set of participant devices, synchronization playback information indicative of a second time position to initiate playback of the media content stream using a synchronization clock, the synchronization playback information incorporating an offset of the playback position information of each participant device relative to playback position information obtained for other participant devices in the synchronization group; and
causing playback of the media content stream by each participant device in the synchronization group based on synchronization playback information for each participant device in the synchronization group.

19. The non-transitory machine-readable medium of claim 18, further comprising:
distributing an authorization token to each participant device in the set of participant devices, each authorization token including a unique client session identifier identifying the media content stream;
obtaining a request to join the media content stream from the first participant device of the set of participant devices in the synchronization group, the request including the authorization token;
responsive to obtaining the request to join the media content stream from the first participant device, identifying the media content stream based on the unique client session identifier identified in the authorization token; and
adding the first participant device to the synchronization group based on identifying the media content stream from the authorization token provided by the first participant device.

20. The non-transitory machine-readable medium of claim 18, further comprising:
obtaining updated playback position information from each participant device of the set of participant devices;
deriving, for each participant device of the set of participant devices, updated synchronization playback information indicative of an updated second time position to playback the media content stream at an updated second time position using the synchronization clock, each participant device configured to update playback of the media content stream based on the updated synchronization playback information.

21. The non-transitory machine-readable medium of claim 18, wherein the media content stream is played on a media player application executing on each participant device in the synchronization group, and wherein each participant device is configured to subscribe to and retrieve a unique instance of the media content stream from a content delivery node.

22. The non-transitory machine-readable medium of claim 18, further comprising:
detecting a state change request to modify a state of playback of the media content stream from any participant device in the synchronization group, the state of playback including any of a play state, a pause state, a stop state, a fast-forward state, and a rewind state;
responsive to detecting the state change request, causing modification of playback on each participant device according to the state of playback to be modified in the state change request.

23. The non-transitory machine-readable medium of claim 18, further comprising:
determining, at a first time, that a network bandwidth of a second participant device in the synchronization group falls below a threshold network bandwidth level;
stopping playback of the media content stream for all participant devices in the synchronization group;
determining, at a second time, that the network bandwidth of the second participant device in the synchronization group exceeds the threshold network bandwidth level;
responsive to determining that the network bandwidth of the second participant device exceeds the threshold network bandwidth level, causing playback of the media content stream to resume on each participant device in the synchronization group.

24. The non-transitory machine-readable medium of claim 23, further comprising:
causing playback of advertising content on all participant devices in the synchronization group other than the second participant device according to the synchronization playback information; and
stopping playback of the advertising content responsive to determining that the network bandwidth of the second participant device exceeds the threshold network bandwidth level.

25. The non-transitory machine-readable medium of claim 18, wherein causing playback of the media content stream by each participant device in the synchronization group further comprises:
causing display of video associated with the media content stream on a first portion of a display of each participant device; and
causing display of video captured on a camera associated with each participant device on a second portion of the display of each participant device, each participant device configured to output audio from both the media content stream and from audio components on each participant device.

26. The non-transitory machine-readable medium of claim 18, further comprising:
obtaining, from a plurality of secondary participant devices, secondary playback information that includes audio and video data captured by sensors of each secondary participant device,
wherein each secondary participant device is associated with a participant device in the synchronization group;
deriving, for each secondary participant device, secondary synchronization playback information indicative of a third time position to initiate playback of the secondary playback information on each secondary participant device using the synchronization clock; and
causing playback of the secondary playback information on each secondary participant device according to the secondary synchronization playback information, wherein playback of the secondary playback information corresponds to playback of the media content stream on the participant devices in the synchronization group.
